(19) United States
(12) Patent Application Publication
(10) Pub. No.: US 2012/0119663 A1
(43) Pub. Date: May 17, 2012

(54) LIGHT EMITTING DIODE CURRENT CONTROL CIRCUIT CAPABLE OF ENERGY RECYCLING

(76) Inventors: Szu-Ming Chiang, Hsin-Chu (TW); Wei-Ming Chen, Hsin-Chu (TW)

(21) Appl. No.: 12/980,356

(22) Filed: Dec. 29, 2010

(30) Foreign Application Priority Data
Nov. 12, 2010 (TW) 099138987

(51) Int. Cl. H05B 37/02

(52) U.S. Cl. 315/185 R

(57) ABSTRACT

Alight emitting diode current control circuit capable of energy recycling includes at least one diode and at least one converter. The diode has an anode terminal, and a cathode terminal for coupling to a first terminal of at least one series of light emitting diodes. The converter has a first terminal coupled to an anode terminal of a corresponding diode, a second terminal for coupling to a second terminal of a series of light emitting diodes corresponding to the converter, a third terminal, and a fourth terminal coupled to ground.

### BACKGROUND OF THE INVENTION

1. Field of the Invention

The present invention is related to a light emitting diode current control circuit, and particularly to a light emitting diode current control circuit capable of energy recycling.

2. Description of the Prior Art

Please refer to FIG. 1. FIG. 1 is a diagram illustrating a light emitting diode current control circuit 100 according to the prior art. The current control circuit 100 includes a current control unit 102 and a plurality of bipolars Q1-Qm. A first terminal of each series of light emitting diodes of a plurality of series of light emitting diodes LED1-LEDm is used for receiving a first voltage VCC. The current control unit 102 is coupled to a second terminal of each series of light emitting diodes for detecting a current flowing through each series of light emitting diodes, and outputting a current control signal to a base terminal of a bipolar corresponding to each series of light emitting diodes according to the current flowing through each series of light emitting diodes. Then, the bipolar controls a current flowing through a series of light emitting diodes corresponding to the bipolar according to the current control signal.

Please refer to FIG. 2. FIG. 2 is a diagram illustrating a light emitting diode current control circuit 200 according to the prior art. The current control circuit 200 includes a current control unit 202 and a plurality of N-type metal-oxide-semiconductor transistors T1-Tm. A first terminal of each series of light emitting diodes of a plurality of series of light emitting diodes LED1-LEDm is used for receiving a first voltage VCC. The current control unit 202 is coupled to a second terminal of each series of light emitting diodes for detecting a current flowing through each series of light emitting diodes, and outputting a current control signal to a gate terminal of an N-type metal-oxide-semiconductor transistor corresponding to each series of light emitting diodes according to a current flowing through each series of light emitting diodes. Then the N-type metal-oxide-semiconductor transistor controls a current flowing through a series of light emitting diodes corresponding to the N-type metal-oxide-semiconductor transistor according to the current control signal.

As shown in FIG. 1, the current control units 102 are used for detecting the current flowing through each series of light emitting diodes, and outputting the current control signal to the base terminal of the corresponding bipolar according to the current flowing through each series of light emitting diodes to change an impedance of the corresponding bipolar and control the current flowing through each series of light emitting diodes. Further, subsequent operational principles of the current control circuit 200 are the same as those of the current control circuit 100, so further description thereof is omitted for simplicity.

However, when variation of forward voltage drops among the plurality of series of light emitting diodes is large and the current flowing through each series of light emitting diodes increases, power loss in the bipolar and the N-type metal-oxide-semiconductor transistor also increase, resulting in lower efficiency of the current control circuit. This can cause that the operating temperature of the current control circuit increases. Therefore, in order to prevent the current control circuit from being burned out, the current control circuit needs a better cooling method to reduce its operating temperature.

### SUMMARY OF THE INVENTION

An embodiment provides a light emitting diode current control circuit capable of energy recycling. The current control circuit includes at least one diode and at least one converter. The diode has an anode terminal, and a cathode terminal for coupling to a first terminal of at least one series of light emitting diodes. The converter has a first terminal coupled to an anode terminal of a corresponding diode, a second terminal for coupling to a second terminal of a series of light emitting diodes, a third terminal, and a fourth terminal coupled to ground.

The present invention provides a light emitting diode current control circuit capable of energy recycling. The light emitting diode current control circuit utilizes at least one current control unit to detect a current flowing through each series of light emitting diodes, and to individually control the current flowing through each series of light emitting diodes through a converter corresponding to each series of light emitting diodes. In addition, each converter delivers the energy delivered by a corresponding series of light emitting diodes to a first voltage through a corresponding diode to achieve an energy recycling function.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a light emitting diode current control circuit according to the prior art.

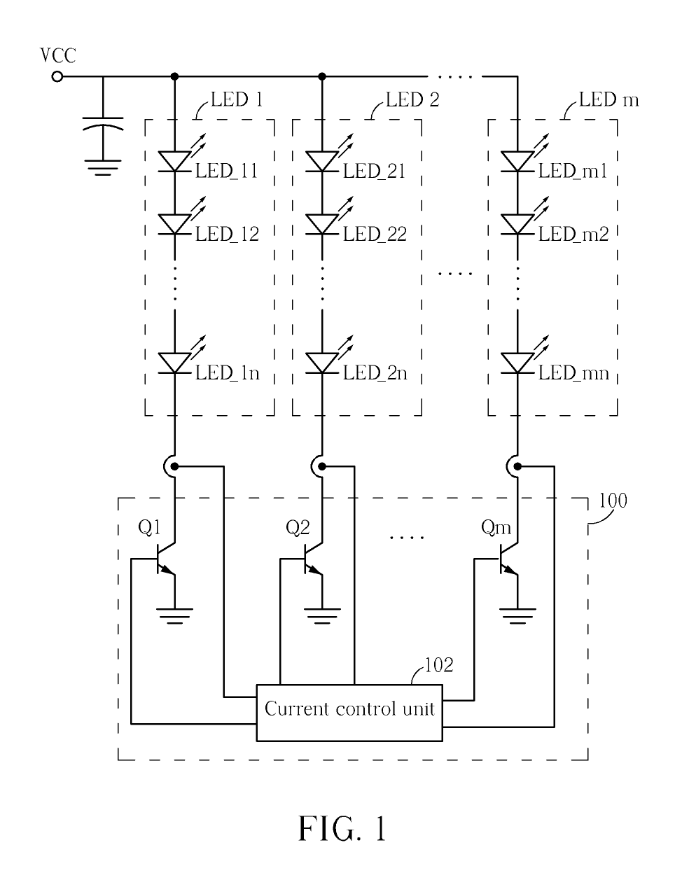

FIG. 2 is a diagram illustrating a light emitting diode current control circuit according to the prior art.

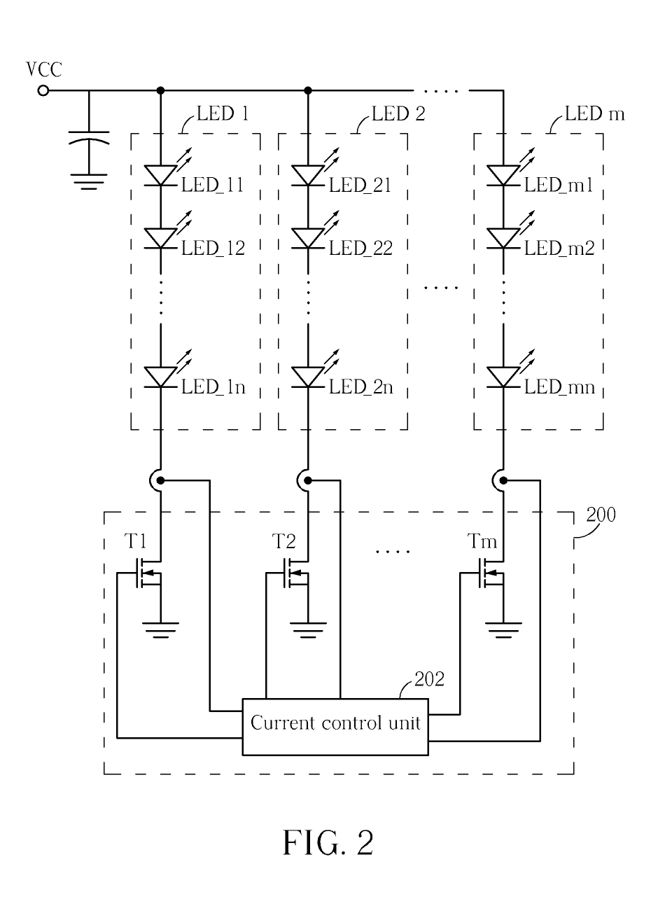

FIG. 3 is a diagram illustrating a light emitting diode current control circuit capable of energy recycling according to an embodiment.

FIG. 4 is a diagram illustrating a light emitting diode current control circuit capable of energy recycling according to another embodiment.

FIG. 5 is a diagram illustrating a light emitting diode current control circuit capable of energy recycling according to another embodiment.

### DETAILED DESCRIPTION

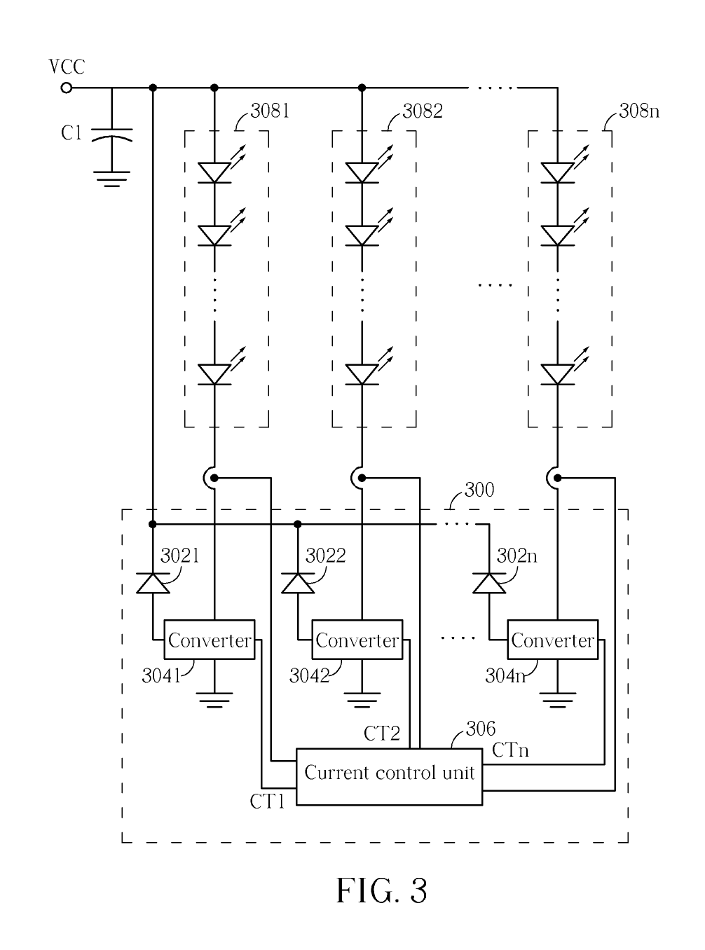

Please refer to FIG. 3. FIG. 3 is a diagram illustrating a light emitting diode current control circuit 300 capable of energy recycling according to an embodiment. The current control circuit 300 includes diodes 3021-302n, converters 3041-304n, and a current control unit 306, where n≧1. Each diode has an anode terminal, and a cathode terminal for coupling to a first terminal of at least one series of light emitting diodes 3081-308n. As shown in FIG. 3, each series of light emitting diodes of the at least one series of light emitting diodes 3081-308n includes at least one series light emitting diode. Each converter has a first terminal coupled to an anode terminal of a corresponding diode, a second terminal coupled to a second terminal of a corresponding series of light emitting diodes, a third terminal coupled to the current control unit 306, and a fourth terminal coupled to ground. For example, the converter 3041 has a first terminal coupled to an anode terminal of the diode 3021, a second terminal coupled to a second terminal of a series of light emitting diodes 3081, a third terminal coupled to the current control unit 306, and a fourth terminal coupled to the ground. The converters 3041-304n are boost circuits. The current control unit 306 is coupled to the third terminal of each converter, and coupled to a second terminal of each series of light emitting diodes for detecting a current flowing through each series of light emitting diodes, and outputting a current control signal to a third terminal of a converter corresponding to each series of light emitting diodes. For example, the current control unit 306 is coupled to the second terminal of a series of light emitting diodes 3081 for detecting a current flowing through the series of light emitting diodes 3081, and outputting a current control signal CT1 to the third terminal of the converter 3041 for controlling the current flowing through the series of light emitting diodes 3081. Therefore, the current control unit 306 can individually control the current flowing through each series of light emitting diodes through the converters 3041-304n. A first terminal of the at least one series of light emitting diodes 3081-308n is used for receiving a first voltage VCC, and a capacitor C1 is used for stabilizing the first voltage VCC. As shown in FIG. 3, each converter can deliver the energy delivered by a corresponding series of light emitting diodes to the first voltage VCC through a corresponding diode to achieve an energy recycling function.

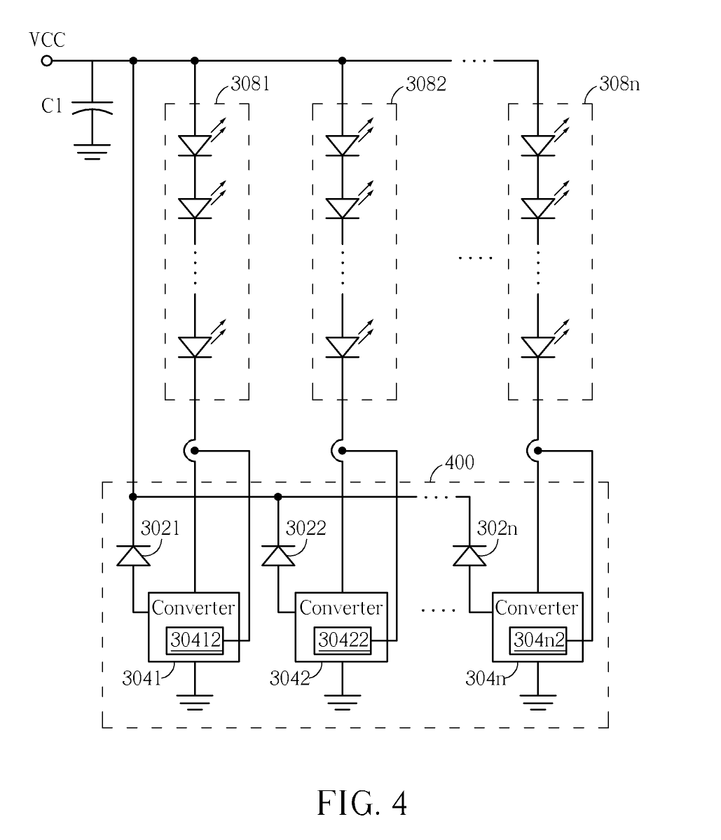

Please refer to FIG. 4. FIG. 4 is a diagram illustrating a light emitting diode current control circuit 400 capable of energy recycling according to another embodiment. A difference between the current control circuit 400 and the current control circuit 300 is that each converter of the current control circuit 400 further includes a current control unit, so the current control circuit 400 does not include the current control unit 306. For example, the converter 3041 further includes a current control unit 30412, and a converter 3042 further includes a current control unit 30422, and so on. The current control unit of each converter is used for detecting a current flowing through a series of light emitting diodes corresponding to the current control unit through the third terminal of the converter, and controlling the current flowing through the series of light emitting diodes corresponding to the current control unit through the second terminal of the converter. For example, a current control unit 30412 of the converter 3041 is used for detecting the current flowing through the series of light emitting diodes 3081 through the third terminal of the converter 3041, and controlling the current flowing through the series of light emitting diodes 3081 through the second terminal of the converter 3041. Further, subsequent operational principles of the current control circuit 400 are the same as those of the current control circuit 300, so further description thereof is omitted for simplicity.

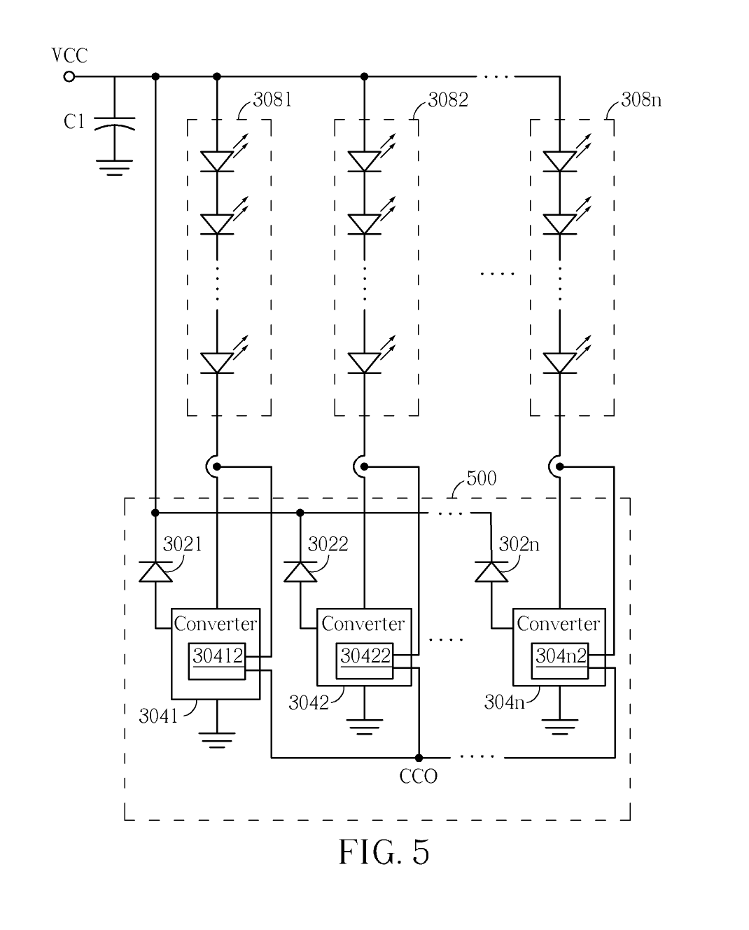

Please refer to FIG. 5. FIG. 5 is a diagram illustrating a light emitting diode current control circuit 500 capable of energy recycling according to another embodiment. A difference between the current control circuit 500 and the current control circuit 300 is that each converter of the current control circuit 500 further includes a current control unit, and the current control circuit 500 has a master-slave current control circuit topology. In the current control circuit 500, a converter of the converters 3041-304n is a master converter, and another converter of the converters 3041-304n is a slave converter. The master converter is used for transmitting a current control command CCO to the another converter (slave converter) of the converters 3041-304n, so the current control circuit 500 does not include the current control unit 306. For example, the current control unit 30412 of the converter 3041 (master converter) transmits the current control command CCO to the current control units 30422-304n2 of the converters 3042-304n (slave converters), where n≧2. The current control unit of each converter is used for detecting a current flowing through a series of light emitting diodes corresponding to the current control unit through the third terminal of the converter, and controlling the current flowing through the series of light emitting diodes through the second terminal of the converter according to the current flowing through the series of light emitting diodes and the current control command CCO. For example, the current control unit 30412 of the converter 3041 is used for detecting the current flowing through the series of light emitting diodes 3081 through the third terminal of the converter 3041, and controlling the current flowing through the series of light emitting diodes 3081 through the second terminal of the converter 3041 according to the current flowing through the series of light emitting diodes 3081 and the current control command CCO. However, the present invention is not limited to the converter 3041 being the master converter, and any of the converters 3042-304n can also act as the master converter. Further, subsequent operational principles of the current control circuit 500 are the same as those of the current control circuit 300, so further description thereof is omitted for simplicity.

To sum up, the light emitting diode current control circuit capable of energy recycling utilizes the current control unit to detect the current flowing through each series of light emitting diodes, and to individually control the current flowing through each series of light emitting diodes through the converter corresponding to each series of light emitting diodes. In addition, each converter delivers the energy delivered by the corresponding series of light emitting diodes to the first voltage through the corresponding diode to achieve the energy recycling function.

Those skilled in the art will readily observe that numerous modifications and alterations of the device and method may be made while retaining the teachings of the invention.

What is claimed is:

1. A light emitting diode current control circuit capable of energy recycling, the light emitting diode current control circuit comprising:
at least one diode having an anode terminal, and a cathode terminal for coupling to a first terminal of at least one series of light emitting diodes; and
at least one converter, each converter having a first terminal coupled to an anode terminal of a corresponding diode, a second terminal for coupling to a second terminal of a series of light emitting diodes corresponding to the converter, a third terminal, and a fourth terminal coupled to ground.

2. The light emitting diode current control circuit of claim 1, further comprising:
a current control unit coupled to the third terminal of each converter, and coupled to a second terminal of each series of light emitting diodes for detecting a current flowing through the series of light emitting diodes, and for outputting a current control signal to the third terminal of the converter corresponding to the series of light emitting diodes.

3. The light emitting diode current control circuit of claim 1, wherein each converter further comprises:
a current control unit for detecting a current flowing through a series of light emitting diodes corresponding to the current control unit through the third terminal of the converter, and controlling the current flowing through the series of light emitting diodes through the second terminal of the converter.

4. The light emitting diode current control circuit of claim 1, wherein a converter of the at least one converter is a master converter, and another converter of the at least one converter is a slave converter, wherein the master converter is used for transmitting a current control command to the another converter of the at least one converter.

5. The light emitting diode current control circuit of claim 4, wherein each converter further comprises:
a current control unit for detecting a current flowing through a series of light emitting diodes corresponding to the current control unit through the third terminal of the converter, and controlling the current flowing through the series of light emitting diodes through the second terminal of the converter according to the current flowing through the series of light emitting diodes and the current control command.

6. The light emitting diode current control circuit of claim 1, wherein the at least one converter is a boost circuit.
